(19) United States
(12) Patent Application Publication
(10) Pub. No.: US 2011/0016658 A1
(43) Pub. Date: Jan. 27, 2011

(54) Hand-held drain clearing device

(76) Inventor: Hong Xia, Shanghai (CN)

Correspondence Address: BACON & THOMAS, PLLC, 625 SLATERS LANE, FOURTH FLOOR, ALEXANDRIA, VA, 22314-1176, US

(21) Appl. No.: 12/458,751

(22) Filed: Jul. 22, 2009

(51) Int. Cl. B08B 9/032

(52) U.S. Cl. 15/344

(57) ABSTRACT

A handheld drain clearing device includes a first compressed air collection chamber and a cylindrical chamber for housing a cylinder. The central axis of said cylindrical chamber coincides with the central axis of said first compressed air collection chamber. A second compressed air collection chamber is formed within said cylindrical chamber and extends into said first compressed air collection chamber. To operate, a user first pushes the air into the second compressed air collection chamber, and then further pushes said cylinder inward to force said compressed air through a gate, into the first compressed air collection chamber. Finally, use a trigger component to discharge the highly compressed air to clear the blockage.

### FIELD OF THE INVENTION

The present invention relates to the field of drain clearing devices, and more particularly, to a device for generating compressed air to unblock household drain pipes, tubs, basins, sinks, and toilets.

### BACKGROUND OF THE INVENTION

In the market, there are all kinds of drain clearing devices for enabling user to clear the blockage of their household drains, pipes. Most of the conventional clearing device comprises a rubber suction cup attached to the end of a handle. When operating, the user utilizes the suction cup to cover the mouth of the blocked pipe, and then forces the handle to move up and down so that the suction cup creates a suction force at the mouth of the blocked pipe. This force, either sucks or pushes the air inside the pipe depending on the direction of operation of this hand-held clearing device, will yield a shock to the blocked pipe so that the blockage will be moved away.

U.S. Pat. No. 7,350,265 provides a new and improved hand-held drain clearing device. Referring to FIG. 1, the device comprises an upper body 10 and a lower body 20. The upper body 10 includes a cylindrical chamber for housing a manual pump 11. The lower body 20 of the device primarily serves as a storage area for compressed air. A one-way inlet valve (one-way valve is also called check valve) allows compressed air to enter the lower body 20 from the manual pump 11 located in the upper body 10. Additionally, an angle is existed between the upper body 10 and the lower body 20. To operate, the user holds the upper body 10 and handles the manual pump 11 to push the compressed air into the lower body 20. When the air pressure in the lower body 20 reaches a predetermined level, the user rapidly releases the compressed air out of the lower body 20, which creates a sudden air burst to clear the pipe.

### SUMMARY OF THE INVENTION

A preferred embodiment of the present invention provides a handheld drain clearing device comprising a compressed air collection chamber having a upper end and a lower end, a first air discharge passage defined in said lower end; a cylindrical chamber formed on said upper end, a cylinder slidably positioned within said cylindrical chamber; wherein a central axis of said cylindrical chamber coinciding with that of said compressed air collection chamber.

As the central axis of said cylindrical chamber coincides with that of said compressed air collection chamber, the handheld drain clearing device is linear in shape so that the clearing device can not easily be stuck when engaged in clearing the drains which have relatively small openings. Furthermore, for its linear structure, the length of the clearing device is increased so that when operating, user can hold the position which is relatively far from the blocked drain to evade the splashing of water.

Another objective of a preferred embodiment of the present invention provides a handheld drain clearing device further comprising a first compressed air collection chamber and a second compressed air collection chamber. Said second compressed air collection chamber is formed within said cylindrical chamber and the lower end of the second compressed air collection chamber extends into said first compressed air collection chamber. A one-way air inlet valve is coupled to the upper end of said second compressed air collection chamber, a one-way seating cup is positioned in place between said second compressed air collection chamber and the inner peripheral wall of said cylinder, and a piston is removable positioned on the lower end of said second compressed air collection chamber; said piston has an open end and a closed end, and an air outlet hole is defined in the peripheral wall of the piston.

Another objective of a preferred embodiment of the present invention is that a seal ring is held in place between said piston and said first air discharge passage to ensure the sealing contact between said piston and said first air discharge passage.

A further objective of a preferred embodiment of the present invention is that a hollow adapter connector is formed on the outlet of said first air discharge passage for receiving various types of drain adapters.

Still another objective of a preferred embodiment of the present invention is that a screening fence is fixed in said adapter connector for preventing foreign matter from entering the connector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side view of the handheld drain clearing device of the prior art;

FIG. 2 is a side view of the handheld drain clearing device of the present invention;

FIG. 3 is a partial cross-sectional view of the handheld drain clearing device of the present invention;

FIG. 4 is a diagram providing further details of the one-way seating cup;

FIG. 5 is a diagram providing further details of the piston;

FIG. 6 is a diagram providing further details of the trigger component; and

FIG. 7 is a partial cross-sectional view of the handheld drain clearing device with a drain-sealing adapter.

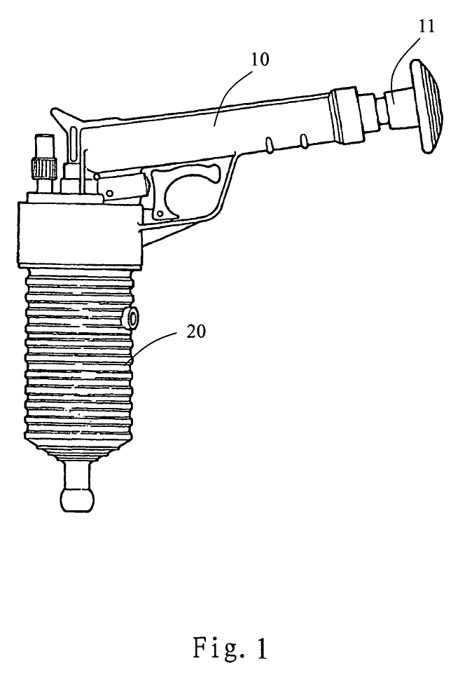

### DETAILED DESCRIPTION OF THE PREFERRED EMBODIMENT

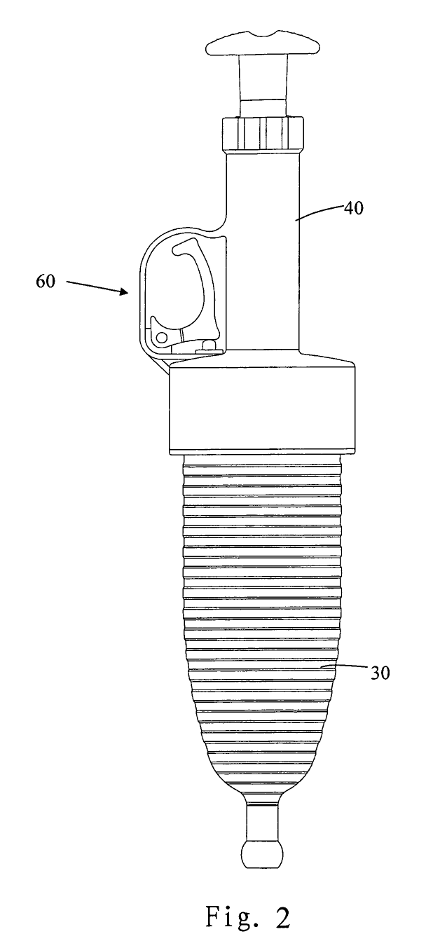

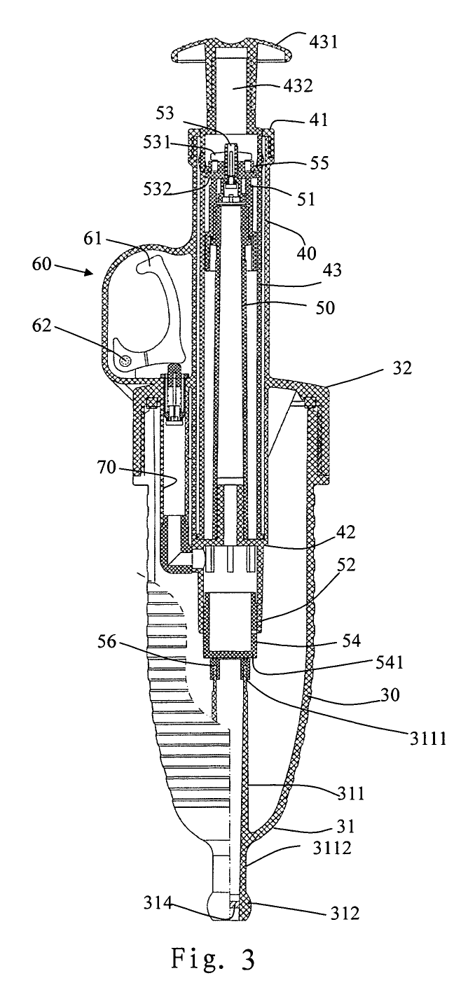

With reference to FIGS. 2 and 3, it is to be noted that in one embodiment of the present invention of the handheld drain clearing device is composed of a first compressed air collection chamber 30, a cylindrical chamber 40, a second compressed air collection chamber 50, and a trigger component 60.

The first compressed air collection chamber 30 comprises a first end 31 and a second end 32. A first air discharge passage 311 is defined in the first end 31 of the first compressed air collection chamber 30, the upper end 3111 of the first air discharge passage 311 extends into the first compressed air collection chamber 30, and lower end 3112 of the first air discharge passage 31 extends out of the first compressed air collection chamber 30. An adapter connector 312 is also formed on an outer periphery of said first end 31 and extends out of first compressed air collection chamber 30. The adapter connector 312 is hollow to communicate with the first air discharge passage 311 and house a screening fence 314 for preventing foreign matter from entering the adapter connector 312.

The cylindrical chamber 40 is formed on the second end 32 of the first compressed air collection chamber 30 and partly extends into the first compressed air collection chamber 30. The cylindrical chamber 40 includes a top end 41 and a bottom end 42. A cylinder 43 is slidably positioned inside said cylindrical chamber 40. The upper end of the cylinder 43 is connected to cylinder handle 431, and the lower end of the cylinder 43 extends through the top end 41 into said cylindrical chamber 40. Additionally, the central axis of the cylindrical chamber 40 coincides with the central axis of first compressed air collection chamber 30 so that the handheld drain clearing device is linear in shape.

The second compressed air collection chamber 50 is formed within the cylindrical chamber 30, the second compressed air collection chamber 50 has an upper end 51 and a lower end 52. The upper end 51 of the second compressed air collection chamber 50 extends upward into the cylinder 43. The lower end 52 of the second compressed air collection chamber 50 extends through the bottom end 42 of the cylindrical chamber 30 into the first compressed air collection chamber 30. A one-way air inlet valve 53 is defined in the upper end 51 of the second compressed air collection chamber 50 to ensure that air only goes in one direction. A piston 54 is slidably positioned inside the lower end 52 of the second compressed air collection chamber 50, the lower end 541 of the piston 54 keeps in touch with the upper end 3111 of the first air discharge passage 311. Additionally, a one-way seating cup 55 is positioned between the second compressed air collection chamber 50 and the inner peripheral wall of the cylinder 43. Thus, an air storage space 432 is bounded by the handle 431, the upper end 51 of the second compressed air collection chamber 50 and the inner peripheral wall of the cylinder 43.

When the cylinder 43 is pulled away from the second compressed air collection chamber 50, the air storage space 432 is gradually expanded and air flows through the one-way seating cup 55 into the air storage space 432 and, when the cylinder 43 is pushed towards the second compressed air collection chamber 50, the air storage space 432 is contracted and the one-way seating cup 55 ensures that air inside the air storage space 432 will not be released from the air storage space 432 and totally forced through the one-way air inlet valve 53 into the second compressed air collection chamber 50.

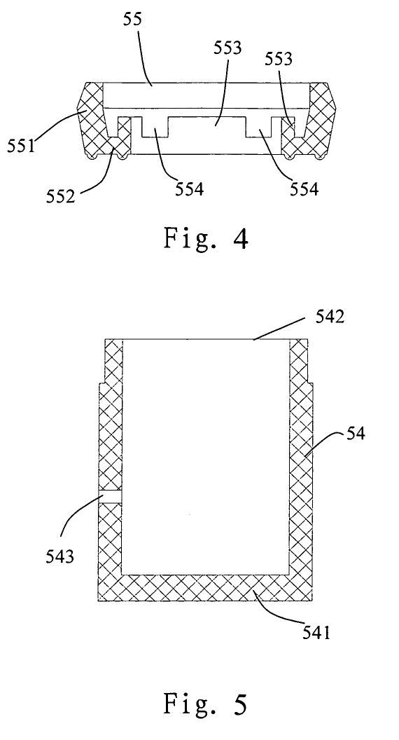

Referring to FIG. 4 and still taking FIG. 3 for reference, the upper end 51 of the second compressed air collection chamber 50 has an upper remaining side 531 and a lower remaining side 532, and the one-way seating cup 55 is positioned in the area bounded by the upper remaining side 531 and the lower remaining side 532. The one-way seating cup 55 comprises a ring 551 and a cyclic bottom 552. Several props 553 are formed on the cyclic bottom 552, and intervals 554 are defined in neighboring props 553. When the cylinder 43 is pulled away from the second compressed air collection chamber 50, the one-way seating cup 55 will be pulled up by the friction generated between the ring 551 and the cylinder 43, and the cyclic bottom 552 will lose sealing contact with the lower remaining side 532 resulting in air flowing through the intervals 554 into the air storage space 432 and, when the cylinder 43 is pushed towards the second compressed air collection chamber 50, the one-way seating cup 55 will be pushed down and the cyclic bottom 552 will seal the lower remaining side 532 resulting in preventing air releasing from the air storage space 432.

Referring to FIG. 5, a diagram provides further details of the piston 54. As indicated in FIG. 4, (with reference to FIG. 2) the piston 54 has an closed lower end 541 and an open upper end 542, and an air outlet hole 543 is defined in the peripheral wall of the piston 54. In use, when the air is in a compressed mode, the closed end 541 of the piston 54 is forced to seal the upper end 3111 of the first air discharge passage 311, resulting in the exposure of the air outlet hole 543 from which the compressed air flows into the first compressed air collection chamber 30. And when the air is in a releasing mode, the air pressure suddenly becomes unequal between the first compressed air collection chamber 30 and the second compressed air collection chamber 50 and said piston 54 is forced to rebound resulting in losing sealing contact with the first air discharge passage 311. Additionally, a seal ring 56 is coupled to the upper end 3111 of the first air discharge passage 311 for insurance of good sealing performance between the first air discharge passage 311 and the closed end 541.

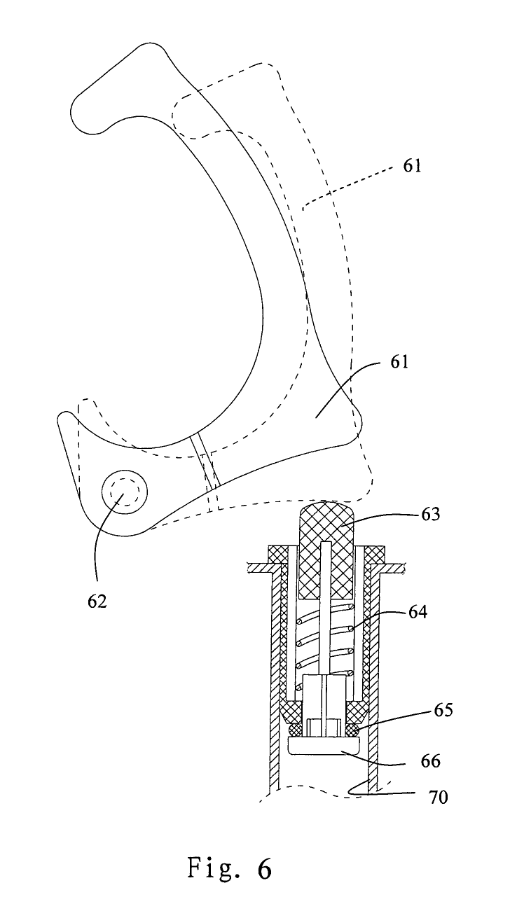

Referring to FIG. 6, (with reference to FIG. 2) a second air discharge passage 70 defined in the second end 32 of the first compressed air collection chamber 30 extends into the first compressed air collection chamber 20 and communicates with the second compressed air collection chamber 50. The trigger component 60 is fixed on the second end 32 to open and close the second air discharge passage 70. The trigger component 60 is composed of a trigger handle 61, a pin 62, a trigger piston 63, a trigger spring 64, a trigger seal packing ring 65, and needle valve 66. The trigger handle 61 is fixed to the first compressed air collection chamber 30 by the pin 32, and has a closed position and a raised position. In the closed position, the trigger handle 61 is untouched with the trigger piston 63, and the trigger spring 64 applies a upward force to the trigger piston 63 forcing the needle valve 66 upward to seal the second air discharge passage 70. When the trigger handle 61 is in this position the user can use cylinder 43 to build up pressure of the air inside the first compressed air collection chamber 30 by continuously forcing air into it. After the user applies a dextrorsal force to the trigger handle 61, the trigger handle 61 is lowered relative to the pin 62 and the trigger handle 61 is in the raised position. In the raised position, the trigger handle 61 is touched with and applies a force to trigger piston 66, compressing the spring 64 to force needle valve 66 outward and open the second air discharge passage 70. This action allows compressed air inside the second compressed air collection chamber 50 to be released through the second air discharge passage 70. During this process, the air pressure suddenly becomes unequal between the first compressed air collection chamber 30 and the second compressed air collection chamber 50, causing piston 54 to quickly rebound and lose sealing contact with the first air discharge passage 311. Compressed air then is rapidly released through the air discharge passage 311, and out of the first compressed air collection chamber 50.

To operate, a user first pulls the cylinder 43 away from the second compressed air collection chamber 50 so that air flows through the one-way seating cup 55 into the air storage space 432. And then, pushing the cylinder 43 towards the second compressed air collection chamber 60 results in forcing the air inside the air storage space 432 into the second compressed air collection chamber 50. Further pushing said cylinder 43 inward will force the compressed air inside the second compressed air collection chamber 50 through the air outlet hole 543 into the first compressed air collection chamber 30. Above-mentioned steps should be repeated until the compressed air in the first compressed air collection chamber 30 reaches a predetermined level. Finally, the highly compressed air is rapidly discharged out of the first compressed air collection chamber 30 by using the trigger component 60, creating a shock to the blocked drain to clear it.

As the central axis of the cylindrical chamber 40 coincides with that of the first compressed air collection chamber 30, the handheld drain clearing device is linear in shape so that the clearing device can not easily be stuck when engaged in clearing the drains which have relatively small openings. Furthermore, for its linear structure, the length of the clearing device is increased so that when operating, user can hold the position which is relatively far from the blocked drain to evade the splashing of water.

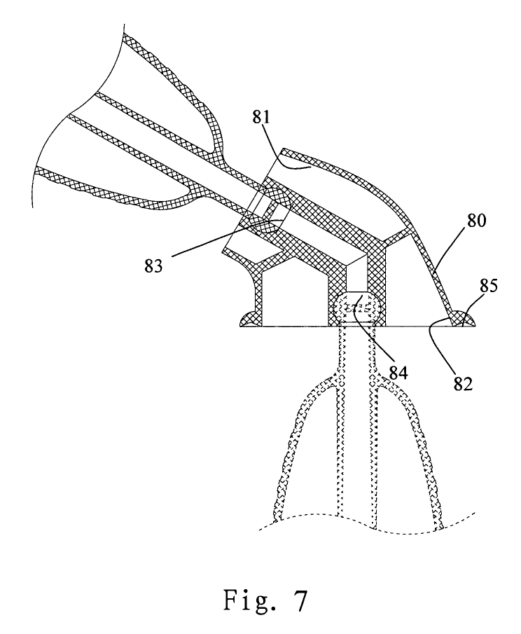

Referring now to FIG. 7, there is shown a partial cross-sectional view of the handheld drain clearing device with a drain-sealing adapter 80. The drain-sealing adapter 80 made of resilient material is arc shaped, and has two ends 81, 82 in which joints 83, 84 are respectively defined for connecting to the adapter connector 312. A packing ring 85 is formed around the outer peripheral wall of the end 82. When operating, if the end 81 is connected to the adapter connector 312, user can utilize the packing ring 85 of the end 82 to cover the mouth of the blocked pipe, on the contrary, if the end 82 is connected to the adapter connector 312, user can utilize the end 81 to go deep into blocked pipe.

Those skilled in the art will readily observe that numerous modifications and alterations of the device and method may be made while retaining the teachings of the invention.

What is claimed is:

1. A handheld drain clearing device comprising:
a compressed air collection chamber having a upper end and a lower end, a first air discharge passage defined in said lower end;
a cylindrical chamber formed on said upper end, a cylinder slidably positioned within said cylindrical chamber;
wherein a central axis of said cylindrical chamber coinciding with that of said compressed air collection chamber.

2. The handheld drain clearing device as claimed in claim 1, wherein said compressed air collection chamber further comprises:
a first compressed air collection chamber having a first end and a second end, said first air discharge passage defined in said first end of said first compressed air collection chamber, said cylindrical chamber formed on said second end of said first compressed air collection chamber;
a second compressed air collection chamber formed within said cylindrical chamber and further extending into said cylinder, a lower end of said second compressed air collection chamber extending through bottom of said cylindrical chamber into said first compressed air collection chamber.

3. The handheld drain clearing device as claimed in claim 2, wherein
a one-way air inlet valve is coupled to an upper end of said second compressed air collection chamber, a one-way seating cup is positioned in place between said second compressed air collection chamber and the inner peripheral wall of said cylinder.

4. The handheld drain clearing device as claimed in claim 2, wherein a piston is movably positioned inside said lower end of said second compressed air collection chamber, said piston has an open end and a closed end, and an air outlet hole is defined in the peripheral wall of said piston;
said piston is positioned such that, in use, in air compressing mode said piston is forced to seal said first air discharge passage, resulting in exposure of said air outlet hole from which said compressed air flows into said first compressed air collection chamber, and in air releasing mode said piston is forced to rebound resulting in losing sealing contact with said first air discharge passage.

5. The handheld drain clearing device as claimed in claim 2, wherein a second air discharge passage is defined in said second end of the first compressed air collection chamber, said second air discharge passage extends into said first compressed air collection chamber and communicates with said second compressed air collection chamber, a trigger component is fixed on the second end of the first compressed air collection chamber to selectively open and close said second air discharge passage.

6. The handheld drain clearing device as claimed in claim 2, wherein a seal ring is held in place between said piston and said first air discharge passage.

7. The handheld drain clearing device as claimed in claim 2, further comprising a hollow adapter connector formed on the outlet of said first air discharge passage.

8. The handheld drain clearing device as claimed in claim 7, a screening fence is fixed in said adapter connector.
